(19) United States
(12) Patent Application Publication
(10) Pub. No.: US 2025/0121870 A1
(43) Pub. Date: Apr. 17, 2025

(54) CARTS WITH BRAKING SYSTEMS

(71) Applicant: Cannon Equipment LLC, Cannon Falls, MN (US)

(72) Inventors: Clemance B. Finstad, Bay City, MN (US); Miraj Jayantibhai Thakkar, Eagan, MN (US)

(73) Assignee: Cannon Equipment LLC, Cannon Falls, MN (US)

(21) Appl. No.: 18/913,340

(22) Filed: Oct. 11, 2024

Related U.S. Application Data
(60) Provisional application No. 63/589,770, filed on Oct. 12, 2023.

(51) Int. Cl. B62B 5/04; B62B 3/00

(52) U.S. Cl. CPC B62B 5/0485; B62B 3/002; B62B 5/0447

(57) ABSTRACT

A cart for transporting objects includes a base with a wheel coupled thereto, a wall extending from the base, a braking system that selectively engages the wheel to thereby slow or prevent movement of the cart, the braking system includes a pair of pivot members coupled to the base that are each pivotable about separate pivot axes, a handle coupled to the wall and movable into and between a first handle position in which the braking system engages the wheel and a second handle position, an actuator member extending between the handle and the pivot members, and moving the handle to the second handle position causes the pivot members to pivot and the braking system to release the wheel.

### CROSS-REFERENCE TO RELATED APPLICATION

The present disclosure is based on and claims priority to U.S. Provisional Patent Application No. 63/589,770 filed Oct. 12, 2023, the disclosure of which is incorporated herein by reference.

### FIELD

The present disclosure relates to carts and specifically to carts with braking systems

### BACKGROUND

The following U.S. Patent Application Publication is incorporated herein by reference in entirety.

U.S. Patent Application Publication No. 2021/0245789 discloses carts for transporting objects having a base and a first end wall and an opposite second end wall extending from the base. A sidewall extends from the base and between the end walls such that the base, the first end wall, the second end wall, and the sidewall define an interior space of the cart. A hinge couples a door to the first end wall such that the door can be pivoted into different positions

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a cart for transporting objects includes a base with a wheel coupled thereto, a wall extending from the base, a braking system that selectively engages the wheel to thereby slow or prevent movement of the cart, the braking system includes a pair of pivot members coupled to the base that are each pivotable about separate pivot axes, a handle coupled to the wall and movable into and between a first handle position in which the braking system engages the wheel and a second handle position, an actuator member extending between the handle and the pivot members, and moving the handle to the second handle position causes the pivot members to pivot and the braking system to release the wheel.

In certain examples, a cart for transporting objects includes a base with a wheel coupled thereto, a wall extending from the base, a braking system that selectively engages the wheel to thereby slow or prevent movement of the cart, the braking system includes a plunger and a cam block, a handle coupled to the wall and movable into and between a first handle position in which the braking system engages the wheel and a second handle position, and when the handle is in the first handle position, the cam block is in a braking position in which the cam block causes the plunger to extend toward the wheel to apply braking forces to the wheel, and when the handle is in the second handle position, the cam block is in a disengaged position in which the plunger is retracted away from the wheel.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example cart according to the present disclosure with a handle in a first handle position.

FIG. 2 is another perspective view of the cart of FIG. 1 with the handle in a second handle position.

FIG. 3 is a bottom-up plan view of a braking system according to the present disclosure in an engaged state.

FIG. 4 is a view like FIG. 3 with the braking system in a disengaged state.

FIG. 5 is a cross-sectional view of an example wheel assembly according to the present disclosure when the braking system is in the engaged state.

FIG. 6 is a view like FIG. 5 when the braking system is in a disengaged state.

FIG. 7 is a perspective view of an example plunger according to the present disclosure.

FIG. 8 is a perspective view of an example cam block according to the present disclosure.

### DETAILED DESCRIPTION

Employees use carts to collect and transport items in facilities, such as warehouses, distribution centers, and commercial stores. Through research and experimentation, the present inventors endeavored to develop carts for safely and efficiently transporting any type of object that are also easily controlled and stopped by the operator. Accordingly, the present inventors developed the example carts described herein below.

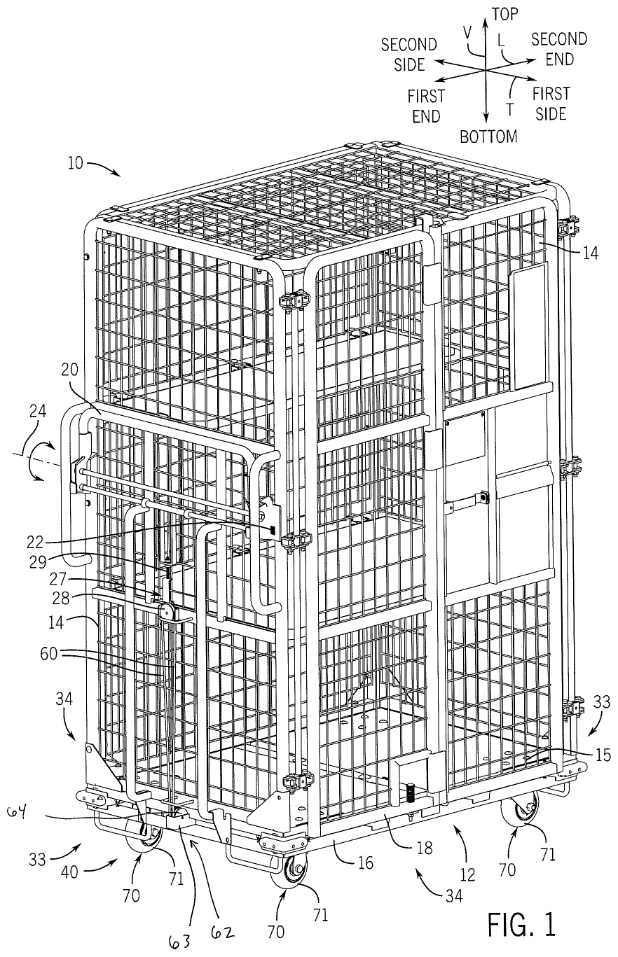

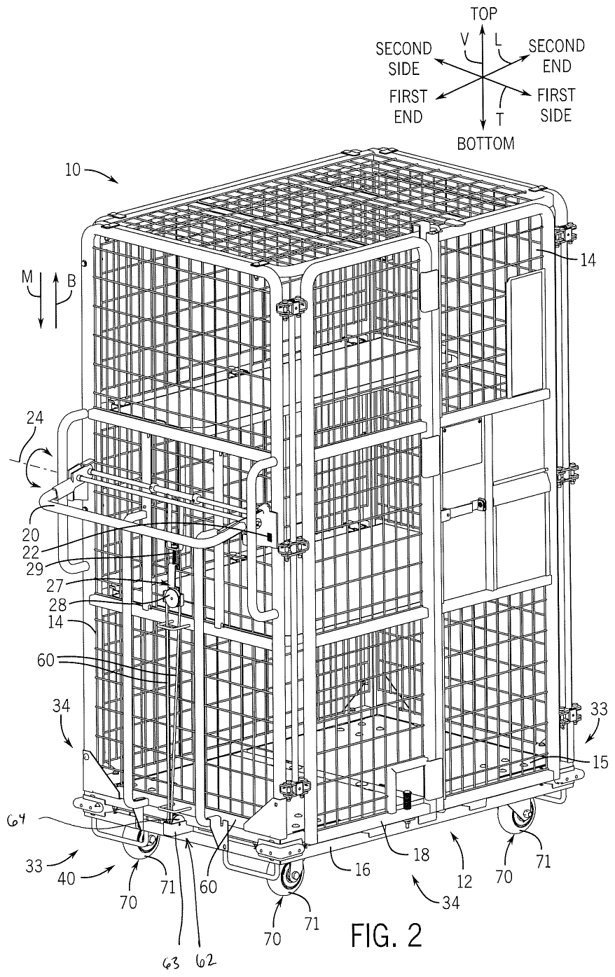

FIGS. 1-2 depict an example cart 10 of the present disclosure. Note that the cart 10 generally vertically extends (see example vertical axis V) between a top and a bottom, laterally extends (see example lateral axis T) between opposing sides 34, and longitudinally extends (sec example longitudinal axis L) between opposing ends 33. The cart 10 has a base 12 and a plurality of walls 14 vertically extending from the base 12. In certain examples, one or more walls 14 include a door 18 to access the interior space defined by the cart 10.

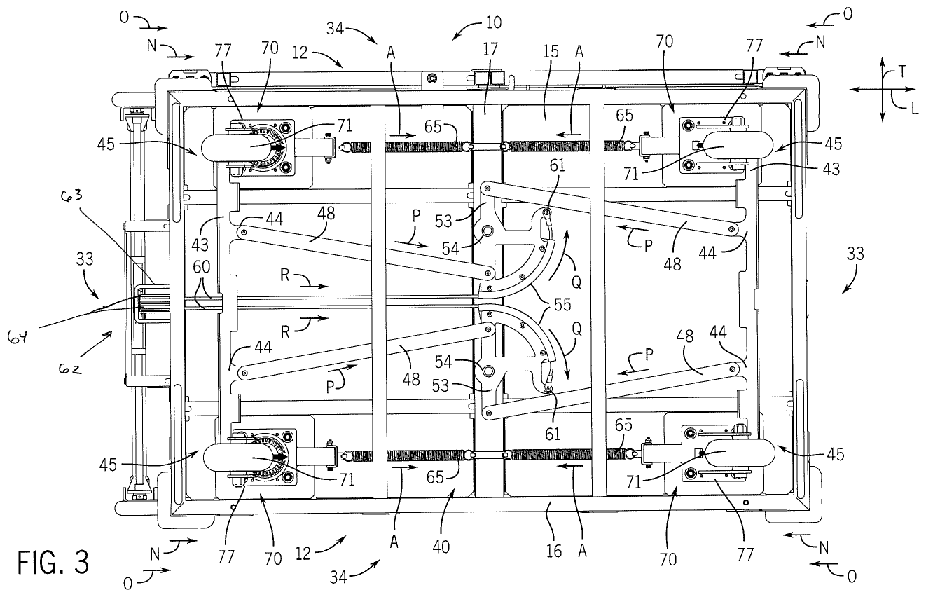

The base 12 is vertically supported on a plurality of wheel assemblies 70. The wheel assemblies 70 are configured to permit the operator to move the cart 10 to different locations. Each wheel assembly 70 includes a base 77 and a wheel 71 or caster that contacts the ground. The base 12 has a plate 15, a perimeter frame 16 (FIG. 3), and a laterally extending crossbar 17 (FIG. 3). Objects placed into the cart 10 rest on the top surface(s) of the plate 15.

The cart 10 includes a handle 20 coupled to one of the walls 14 and the braking system 40. The handle 20 is operable into and between a first handle position (FIG. 1) in which the braking system 40 is in an engaged state such that the braking forces are applied to the wheels 71 to thereby slow or stop movement of the cart 10 and a second handle position (FIG. 2) in which the braking system 40 is in a disengaged state such that no braking forces are applied to the wheels 71 and the cart 10 can be easily moved. The handle 20 pivots about a pivot axis 24. In certain examples, more than one handles 20 are coupled to one or more walls 14, and in these examples, the handles 20 can be collectively or independently operated to change the state of the braking system 40.

The handle 20 is biased toward the first handle position (FIG. 1) by one or more biasing devices 22 (e.g., springs, straps, gas cylinders, electromagnetic solenoids) such that the braking system 40 is biased toward the engaged state. As such, braking forces are applied to the wheel 71 when the handle 20 is not being engaged by the operator and the braking system 40 functions as a “dead-man” braking system (e.g., the handle 20 must be moved toward and/or into the second handle position in order for the cart 10 to be movable). These features of the braking system 40 decrease the risk that the cart 10 will inadvertently move thereby increasing the safety of the operator and surrounding persons and objects.

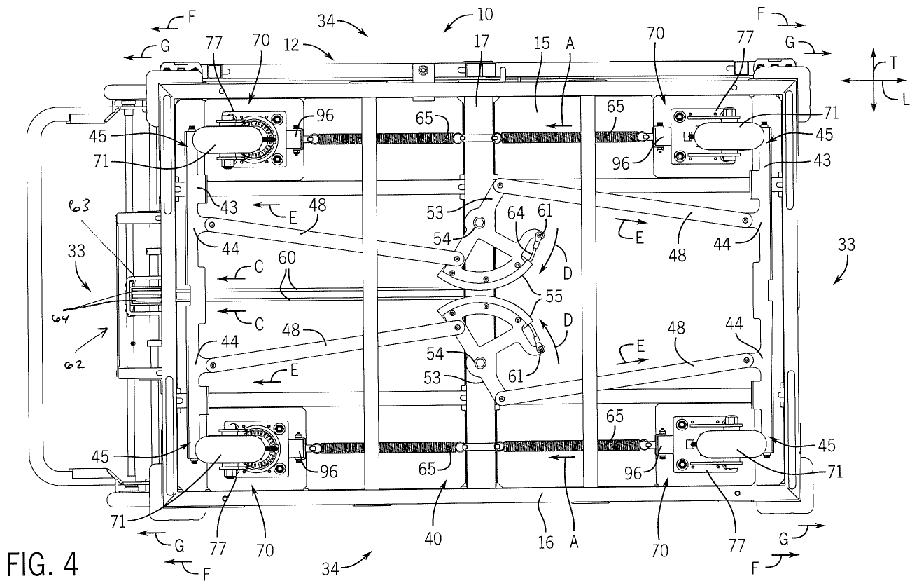

Referring now to FIGS. 3-4, the braking system 40 is depicted in more detail. Several components of the braking system 40 are coupled to the lower or underside of the base 12. A plurality of wheel assemblies 70 are coupled to the bottom surface of the plate 15. The braking system 40 includes one or more first link members 43 that are coupled to the wheel assemblies 70. Specifically, the first link member 43 has a pair of ends 45 and each end 45 is coupled to one of the wheel assemblies 70. Each first link member 43 is longitudinally movable and configured to act on a cam block 96 of the wheel assembly 70 (described further herein). The example braking system 40 depicted in FIG. 3 includes a pair of first link members 43, and each first link member 43 is coupled to a pair of wheel assemblies 70. In this example, the opposing ends 45 of the first link members 43 are coupled to one of wheel assemblies 70.

Each first link member 43 has one or more cars 44 to which a second link member 48 is pivotally coupled. The example braking system 40 defined in FIG. 3 includes two second link members 48 coupled to each first link member 43.

The second link members 48 are also pivotally coupled to a pivot member 53. The pivot member 53 defines a pivot axis 54 about which the pivot member 53 pivots. The pivot members 53 are pivotally coupled to the crossbar 17. The example braking system 40 has two pivot members 53 pivotally coupled to the crossbar 17 and laterally offset from each other. In this example, each of the second link members 48 is coupled to one of the pivot members 53 and one of the first link members 43.

The size and the shape of the pivot member 53 can vary, and in the example depicted in FIG. 3, the pivot member 53 has a semi-circular shape. The pivot member 53 has a curved, outer perimeter surface 55 along which an actuator member such as a linkage, a bar linkage, a cable, or the like extends. In the example depicted in FIGS. 1-4, the actuator member is a cable 60. The cable 60 has a pair of cable ends 61, and each cable end 61 is coupled to one of the pivot members 53. In certain examples, the pivot member 53 has a channel along the outer perimeter surface 55 in which the cable 60 extends. In certain examples, the pivot member 53 includes a leg to which the cable end 61 is coupled. In certain examples, the braking system 40 does not include the actuator member and/or the handle 20.

The cable 60 is longitudinally routed along the base 12, through a guide assembly 62 (see also FIGS. 1-2), and vertically along one of the walls 14. In the example depicted in FIGS. 1-2, the guide assembly 62 includes a bracket 63 that holds two wheels 64 along which sections of the cable 60 extend. The cables 60 longitudinally extend along the base 12 to a pair of pivot members 53 (described further herein), and the cable 60 further vertically extends along one of the walls 14 (FIG. 1).

Another section of the cable 60 between the ends 61 is looped around a pulley 27 (FIG. 1) which is coupled to the handle 20. The pulley 27 includes a wheel 28 and a bracket 29. In certain examples, the bracket 29 includes a rotatable sleeve around a rod of the handle 20 such that the sleeve rotates relative to the rod. As the handle 20 is pivoted from the first handle position (FIG. 1) to the second handle position (FIG. 2), the pulley 27 is moved (e.g., vertically moved see arrow Bon FIG. 2) away from the base 12. As such, the cable 60 is also vertically pulled along the wall (see arrow B in FIG. 2) and longitudinally along the base 12 (see arrow C in FIG. 4) the ends 61 act on the pivot members 53 (described further herein). Alternatively, as the handle 20 is pivoted from the second handle position (FIG. 2) to the first handle position (FIG. 1), the pulley 27 is moved (e.g., vertically moved see arrow M on FIG. 2) toward the base 12. As such, the cable 60 is also vertically pulled along the wall (see arrow M in FIG. 2) and longitudinally along the base 12 (see arrow R in FIG. 4) (described further herein). Note that in other examples the cable 60 can be more than one cable that are coupled together.

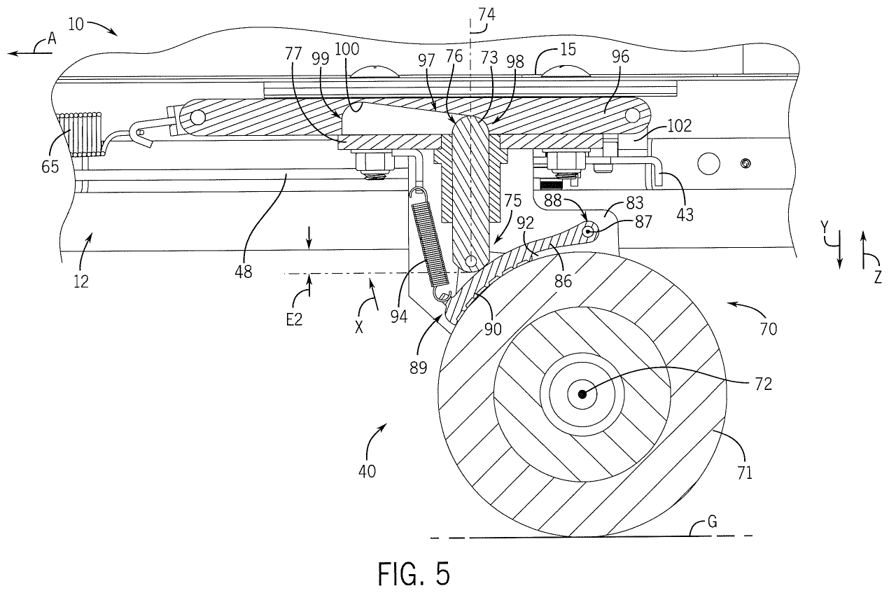

The braking system 40 includes one or more springs 65 coupled to the crossbar 17 and the cam blocks 96. Specifically, one end of the spring 65 is coupled to the crossbar 17 and the other end is coupled to the cam block 96. In certain examples, the end of the spring 65 coupled to the crossbar 17 has a hook or finger that engages the crossbar 17. The spring 65 biases the cam block 96 into a braking position (FIGS. 3 and 5) such that braking forces are applied to the wheel(s) 71 (described in greater detail herein below). Each spring 65 applies a longitudinally directed force (see arrow A in FIG. 3) toward the crossbar 17.

An example operational sequence of the braking system 40 is described herein below with references to FIGS. 3-4.

When the handle 20 is in the first handle position (FIG. 1), the first link members 43, the second link members 48, and the pivot member 53 are in the positions depicted in FIG. 3. The forces applied by the springs 65 to the cam blocks 96 cause braking forces to be applied to the wheels 71 to prevent rotation of the wheels 71. As such, the braking system 40 is in an engaged state and the cart 10 cannot be inadvertently moved.

To move the cart 10, the operator grasps the handle 20 (FIG. 1) and pivots the handle 20 about the pivot axis 24 into the second handle position (FIG. 2) against the biasing forces applied by the biasing devices 22. As such, the pulley 27 is moved vertically upward (see arrow B in FIG. 2), the cable 60 is pulled vertically upward (see arrow B in FIG. 2) and longitudinally away from the crossbar 17 (see arrow C in FIG. 4) and the pivot members 53 are pivoted about the pivot axes 54 (see arrows D in FIG. 4). Note that each pivot member 53 pivots in an opposite direction relative to each other (e.g., one of the pivot members 53 pivots in a clockwise direction and the other pivot member 53 rotates in a counter-clockwise direction). For example, one of the pivot members 53 is pivoted in a first pivot direction and the other of the pivot member 53 is pivoted in a second pivot direction (see arrows Q in FIG. 3).

As the pivot members 53 pivot (see arrows D in FIG. 4), the pivot members 53 longitudinally move the second link members 48 in directions away from the crossbar 17 (see arrows E in FIG. 4) such that the second link members 48 act on the first link member 43 and each first link member 43 is moved in a direction away from the crossbar 17 (see arrows F in FIG. 4). Movement of the first link members 43 away from the crossbar 17 (see arrows F in FIG. 4) causes the cam blocks 96 to be moved into a disengaged position (see arrows G in FIG. 4) against the bias of the springs 65. As such, braking forces normally applied by the wheel assemblies 70 when the handle 20 is in the first handle position (FIG. 1) are removed and no braking forces are applied to the wheels 71 (described in more detail herein below). The operator can now freely move the cart 10. Note that the springs 65 are in stretched states when the cam blocks 96 are moved into the disengaged position.

In the event the operator purposely or inadvertently releases the handle 20, the biasing devices 22 automatically bias and pivot the handle 20 to the first handle position (FIG. 1). As such (as will be described herein below in greater detail), the braking system 40 is moved into the engaged state (FIG. 3) such that braking forces are applied to the wheel 71 and the cart 10 is slowed or stopped.

When the handle 20 is pivoted from the second handle position (FIG. 2) to the first handle position (FIG. 1), the pulling forces applied by the cable 60 to the pivot members 52 are eliminated or released. Accordingly, the spring 65 pulls (see arrow A in FIG. 3) pulls the cam blocks 96 toward the crossbar 17 (see arrow N in FIG. 3). The first link members 43 are moved toward the crossbar 17 (sec arrows O in FIG. 3) and the second link members 48 are moved away from the crossbar 17 (see arrows P in FIG. 3). As such, the pivot members 53 are pivoted about the pivot axis 54 (see arrows Q in FIG. 3) opposite the direction noted above with respect to moving the braking system 40 to the disengaged state. Note that in certain examples, the cables 60 apply pushing forces to the pivot members 53 to further assist the movements of the components described above. As the handle 20 is moved from the second handle position (FIG. 2) to the first handle position (FIG. 1), the pulley 27 and the sections of the cable 60 extending along the wall 14 are moved toward the base 12 (see arrows M in FIG. 2) and the sections of the cable 60 extending along the base 12 are moved toward the crossbar 17 (see arrows R on FIG. 3).

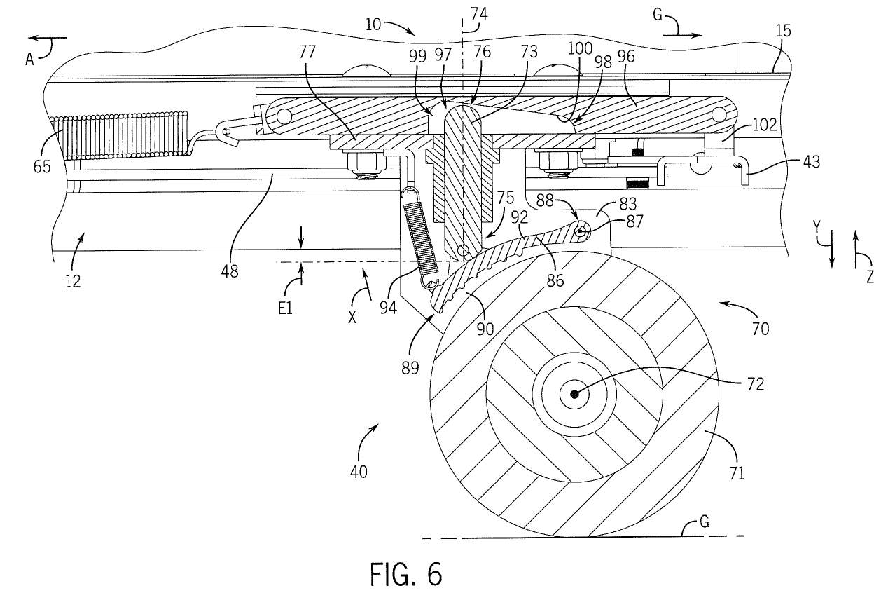

Turning now to FIGS. 5-6, an example wheel assembly 70 of the present disclosure is depicted in greater detail. The wheel assembly 70 is coupled to the base 12, and the wheel 71 is for engaging the ground G. The wheel 71 rotates about a wheel axis 72. A bracket 83 couples the wheel 71 to the base 12. Note that in the example depicted in FIGS. 5-6 the bracket 83 fixes the orientation of the wheel 71 (e.g., the wheel 71 is longitudinally fixed), however, in other examples, the bracket 83 may permit the wheel 71 to rotate about a plunger axis 74.

A brake pad 86 is pivotally coupled to the bracket 83 at a pad axis 87. Specifically, a first pad end 88 is pivotally coupled to the bracket 83 at the pad axis 87. An opposite second pad end 89 is moveable toward and away from the wheel 71. The brake pad 86 has a braking first surface 90 that faces the wheel 71 and an opposite second surface 92 that faces away from the wheel 71. A spring 94 is coupled to the second pad end 89 and is configured to bias the braking first surface 90 away from the wheel 71 (see arrow X). In certain examples, the first surface 90 includes one or more ribs.

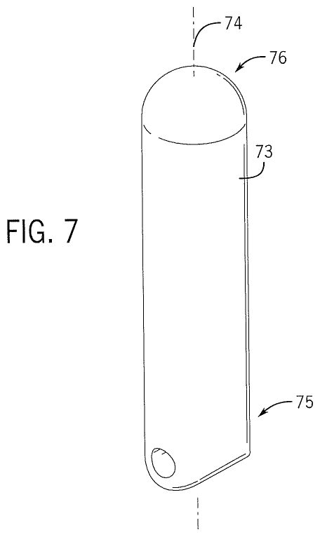

The plunger 73 extends along the plunger axis 74 and has a first plunger end 75 and an opposite second plunger end 76. The plunger 73 is sandwiched between the cam block 96 and the brake pad 86. The first plunger end 75 is configured to selectively engage the second surface 92 of the brake pad 86, and the second plunger end 76 is received into a channel 97 defined in the cam block 96 (described in greater detail herein below). As will be described in greater detail hereinbelow, the plunger 73 is configured to translate or reciprocate in directions parallel with the plunger axis 74 (see arrows Y and Z) and selectively push the brake pad 86 into contact with the wheel 71. FIG. 7 depicts the plunger in greater detail. The shape of the plunger ends 75, 76 can vary. In the example depicted in FIG. 7, the first plunger end 75 is rounded. In the example depicted in FIG. 7, the second plunger end 76 is rounded and generally has a hemispherical shape.

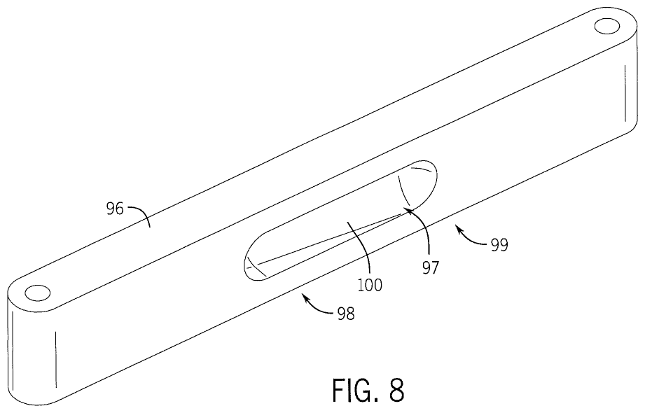

The cam block 96 is coupled at one end to the spring 65 and at the other end a bracket 102 that is coupled to the first link member 43 (see also FIGS. 3-4). As noted above, the second plunger end 76 is received into the channel 97 of the cam block 96. The channel 97 is recessed into the cam block 96 and has opposing channel ends 98, 99. FIG. 8 depicts the cam block 96 in greater detail. The channel 97 is defined in part by a cam surface 100 that is configured to act on and cam the plunger 73 along the plunger axis 74 (see arrows Y and Z) (described in greater detail hereinbelow). The depth of the channel 97 varies. At the first channel end 98, the channel 97 has a first depth D1 and at the second channel end 99, the channel 97 has a second depth D2 that is greater than the first depth D1.

Operation of the wheel assembly 70 and movement of the components thereof are described in greater detail below with respect to FIGS. 5-6. When the braking system 40 is normally in the engaged state (see also FIGS. 1 and 3), the spring 65 biases the cam block 96 to the braking position as depicted in FIG. 5. With the cam block 96 in the braking position, the second plunger end 76 is in the first channel end 98 such that the plunger 73 extends (see first extension distance E1) toward the wheel 71. Despite the biasing force of the spring 94, the plunger 73 acts on and pushes the second surface 93 of the brake pad 86 such that the first surface 90 engages the wheel 71. As such, the braking forces (e.g., compression force, friction force) between the first surface 90 and the wheel 71 prevent or slow rotation of the wheel 71.

As the braking system 40 is moved from the engaged state (see FIGS. 1 and 3) to the disengaged state (see FIGS. 2 and 4), the cam block 96 is moved to the disengaged position (FIG. 6) by the spring 65. For example, the first link member 43 (schematically depicted in FIGS. 5-6) pulls the cam block 96 spring 65 (see arrow G on FIG. 6) against the bias of the spring 65. As such, the plunger 73 retracts into the channel 97 (see second extension distance E2 which is less than the first extension distance E1) due to forces applied to it by way of the spring 94 pulling the brake pad 86 away from the wheel 71 (see arrow X). As such, the brake pad 86 does not engage the wheel 71 and no braking forces are applied to the wheel 71.

After the handle 20 (FIGS. 1-2) is released, the braking system 40 moves from the disengaged state (see FIGS. 2 and 4) to the engaged state (FIGS. 1 and 3) as noted above. The spring 65 pulls (see arrow Aon FIG. 5) the cam block 96 such that the cam surface 100 slides along the second plunger end 76. The cam surface 100 is sloped downwardly in a direction from the second channel end 99 to the first channel end 98 such that cam surface 100 cams the plunger 73 toward the wheel 71 (see arrow Y). The plunger 73 overcomes the biasing force of the spring 94 (as noted above), and the first plunger end 75 pushes the brake pad 86 into engagement with the wheel 71. As such, braking forces are applied to the wheel 71 and the braking system 40 is in the engaged state (FIGS. 1 and 3). In certain examples, the brake pad 86 has a visual check feature such that the operator can quickly check the thickness of the brake pad 86 and determine whether or not the brake pad 86 should be replaced because the thickness of the brake pad 86 is below an acceptable thickness.

In certain examples, a cart for transporting objects includes a base with a wheel coupled thereto, a wall extending from the base, a braking system that selectively engages the wheel to thereby slow or prevent movement of the cart, the braking system includes a pair of pivot members coupled to the base that are each pivotable about separate pivot axes, a handle coupled to the wall and movable into and between a first handle position in which the braking system engages the wheel and a second handle position, an actuator member extending between the handle and the pivot members, and moving the handle to the second handle position causes the pivot members to pivot and the braking system to release the wheel.

Optionally, one of the pivot members is pivoted in a first pivot direction and the other pivot member is pivoted in a second pivot direction. Optionally, the actuator member is a cable with a pair of cable ends each coupled to one of the pivot members. Optionally, each pivot member includes a leg to which the one of the cable ends is coupled. Optionally, the base has a crossbar and the pivot members are coupled to and offset from each other along the crossbar. Optionally, a pulley is coupled to the handle and around which the cable extends. Optionally, the first handle position the handle extends along the wall and in the second handle position the handle extends transverse to the wall. Optionally, a biasing device that biases the handle to the first handle position. Optionally, the braking system includes a plunger and a cam block and when the handle is in the first handle position, the cam block is in a braking position in which the cam block causes the plunger to extend toward the wheel to apply braking forces to the wheel, and when the handle is in the second handle position, the cam block is in a disengaged position in which the plunger is retracted away from the wheel. Optionally, the braking system includes a brake pad, when the cam block is in the braking position the plunger causes the brake pad to apply braking forces to the wheel. Optionally, the braking system includes a spring that biases the cam block to the braking position. Optionally, the base has a crossbar and the pivot members are coupled to and offset from each other along the crossbar and one end of the spring is coupled to the crossbar. Optionally, the cam block has a channel in which the plunger moves, the cam block includes a first channel end in which the plunger is located when the cam block is in the braking position and a second channel end in which the plunger is located when the cam block is in the disengaged position. Optionally, the cam block is translatable along the base. Optionally, the base has opposing ends and the cam block is translatable toward one of the ends. Optionally, the cam block is coupled to the pivot members through one or more link members that extend along the base. Optionally, the braking system includes a plunger and a cam block and when the handle is in the first handle position, the cam block is in a braking position and the plunger extends toward the wheel to apply braking forces to the wheel and when the handle is in the second handle position, the cam block is in a disengaged position such that the plunger is retracted away from the wheel.

In certain examples, a cart for transporting objects includes a base with a wheel coupled thereto, a wall extending from the base, a braking system that selectively engages the wheel to thereby slow or prevent movement of the cart, the braking system includes a plunger and a cam block, a handle coupled to the wall and movable into and between a first handle position in which the braking system engages the wheel and a second handle position, and when the handle is in the first handle position, the cam block is in a braking position in which the cam block causes the plunger to extend toward the wheel to apply braking forces to the wheel, and when the handle is in the second handle position, the cam block is in a disengaged position in which the plunger is retracted away from the wheel.

Optionally, the braking system includes a brake pad, and when the cam block is in the braking position the plunger causes the brake pad to apply braking forces to the wheel. Optionally, the braking system includes a spring that biases the cam block to the braking position. Optionally, the cam block has a channel in which the plunger moves, the cam block includes a first channel end in which the plunger is located when the cam block is in the braking position and a second channel end in which the plunger is located when the cam block is in the disengaged position.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cart for transporting objects, the cart comprising:
a base with a wheel coupled thereto;
a wall extending from the base;
a braking system that selectively engages the wheel to thereby slow or prevent movement of the cart, the braking system includes a pair of pivot members coupled to the base that are each pivotable about separate pivot axes;
a handle coupled to the wall and movable into and between a first handle position in which the braking system engages the wheel and a second handle position;
an actuator member extending between the handle and the pivot members; and
wherein moving the handle to the second handle position causes the pivot members to pivot and the braking system to release the wheel.

2. The cart according to claim 1, wherein one of the pivot members is pivoted in a first pivot direction and the other pivot member is pivoted in a second pivot direction.

3. The cart according to the claim 1 wherein the actuator member is a cable with a pair of cable ends each coupled to one of the pivot members.

4. The cart according to claim 3, wherein each pivot member includes a leg to which the one of the cable ends is coupled.

5. The cart according to claim 1, wherein the base has a crossbar and the pivot members are coupled to and offset from each other along the crossbar.

6. The cart according to claim 3, further comprising a pulley coupled to the handle and around which the cable extends.

7. The cart according to claim 1, wherein in the first handle position the handle extends along the wall and in the second handle position the handle extends transverse to the wall.

8. The cart according to claim 1, further comprising a biasing device that biases the handle to the first handle position.

9. The cart according to claim 1, wherein the braking system includes a plunger and a cam block;
wherein when the handle is in the first handle position, the cam block is in a braking position and the plunger extends toward the wheel to apply braking forces to the wheel; and
wherein when the handle is in the second handle position, the cam block is in a disengaged position such that the plunger is retracted away from the wheel.

10. The cart according to claim 9, wherein the braking system includes a brake pad, wherein when the cam block is in the braking position the plunger causes the brake pad to apply braking forces to the wheel.

11. The cart according to claim 9, wherein the braking system includes a spring that biases the cam block to the braking position.

12. The cart according to claim 11, wherein the base has a crossbar;
wherein the pivot members are coupled to and offset from each other along the crossbar; and
wherein one end of the spring is coupled to the crossbar.

13. The cart according to claim 9, wherein the cam block has a channel in which the plunger moves, the cam block includes a first channel end in which the plunger is located when the cam block is in the braking position and a second channel end in which the plunger is located when the cam block is in the disengaged position.

14. The cart according to claim 9, wherein the cam block is translatable along the base.

15. The cart according to claim 14, wherein the base has opposing ends, and the cam block is translatable toward one of the ends.

16. The cart according to claim 9, wherein the cam block is coupled to the pivot members through one or more link members that extend along the base.

17. A cart for transporting objects, the cart comprising:
a base with a wheel coupled thereto;
a wall extending from the base;
a braking system that selectively engages the wheel to thereby slow or prevent movement of the cart, the braking system includes a plunger and a cam block;
a handle coupled to the wall and movable into and between a first handle position in which the braking system engages the wheel and a second handle position;
wherein when the handle is in the first handle position, the cam block is in a braking position in which the cam block causes the plunger to extend toward the wheel to apply braking forces to the wheel; and
wherein when the handle is in the second handle position, the cam block is in a disengaged position in which the plunger is retracted away from the wheel.

18. The cart according to claim 17, wherein the braking system includes a brake pad, wherein when the cam block is in the braking position the plunger causes the brake pad to apply braking forces to the wheel.

19. The cart according to claim 18, wherein the braking system includes a spring that biases the cam block to the braking position.

20. The cart according to claim 17, wherein the cam block has a channel in which the plunger moves, the cam block includes a first channel end in which the plunger is located when the cam block is in the braking position and a second channel end in which the plunger is located when the cam block is in the disengaged position.
